(19) United States
(12) Patent Application Publication
(10) Pub. No.: US 2025/0315522 A1
(43) Pub. Date: Oct. 9, 2025

(54) INTRUSION DETECTION DEVICE AND INTRUSION DETECTION METHOD

(71) Applicant: HITACHI ASTEMO, LTD., Hitachinaka-shi, Ibaraki (JP)

(72) Inventors: Teruaki NOMURA, Chiyoda-ku, Tokyo (JP); Nobuyoshi MORITA, Chiyoda-ku, Tokyo (JP); Shuhei KANEKO, Chiyoda-ku, Tokyo (JP); Yasuhiro FUJII, Chiyoda-ku, Tokyo (JP); Mikio KATAOKA, Chiyoda-ku, Tokyo (JP)

(73) Assignee: HITACHI ASTEMO, LTD., Hitachinaka-shi, Ibaraki (JP)

(21) Appl. No.: 18/881,635

(22) PCT Filed: Mar. 8, 2023
(86) PCT No.: PCT/JP2023/008921

§ 371 Date: Jan. 6, 2025

(30) Foreign Application Priority Data
Jul. 20, 2022 (JP) 2022-115404

(51) Int. Cl. G06F 21/55

(52) U.S. Cl. CPC G06F 21/554

(57) ABSTRACT

Provided are an intrusion detection device and a detection method that enable detection of unauthorized communication to be performed more accurately. This intrusion detection device includes a communication unit that transmits and receives a frame to and from an in-vehicle electronic device; an attribute acquisition unit that acquires an attribute of the frame; a status acquisition unit that acquires communication control status information indicating a communication control status of the frame by the in-vehicle electronic device; and an abnormality detection unit that detects an abnormality of the in-vehicle electronic device on the basis of the attribute and the communication control status. Even when the number of frames transmitted per unit time is equal to or less than a predetermined value, it is possible to determine an abnormality of the in-vehicle electronic device according to the communication control status of the ECU 20 constituting the transmission source of the frame and the attributes of the frame.

### TECHNICAL FIELD

The present disclosure relates to an intrusion detection device and an intrusion detection method.

### BACKGROUND ART

Conventionally, a plurality of electronic control units (ECUs) including a microcomputer or the like are mounted in an automobile. The plurality of ECUs is connected to an in-vehicle network such as a controller area network (CAN) and communicate with the plurality of ECUs and with external devices.

In recent years, there has been a threat of ECUs being attacked by crackers or the like by means of unauthorized communication from the outside, resulting in control of the vehicle being taken over. To counter such a threat, an intrusion detection system (IDS) is known, which is a technology that, by monitoring communication on a network, detects the occurrence of such attack activity and notifies an administrator or the like. For example, PTL 1 discloses counting the number of counts per unit time of messages periodically transmitted from a communication device and, in a case where the number of counts exceeds a threshold value, determining that attack activity is occurring.

However, in the case of the technology disclosed in PTL 1 disclosed above, it may sometimes be impossible to detect attack activity that should originally be determined to be abnormal. For example, in a case where an attack device (an ECU, an external device, or the like, with which spoofing is performed or in which software has been tampered with) transmits an unauthorized frame in a prescribed cycle, the number of frames transmitted per unit time is equal to or less than a threshold value, and thus, the transmission of the unauthorized frame cannot be detected as unauthorized communication. Therefore, the technology disclosed in PTL 1 may not enable detection of unauthorized communication to be performed accurately.

### CITATION LIST

### Patent Literature

PTL 1: Japanese Patent No. 6891671

### SUMMARY OF INVENTION

### Technical Problem

In view of the above problems, the present disclosure provides an intrusion detection device and a detection method that enable detection of unauthorized communication to be performed more accurately.

### Solution to Problem

An intrusion detection device according to a first embodiment of the present disclosure includes a communication unit that transmits and receives a frame to and from an in-vehicle electronic device; an attribute acquisition unit that acquires an attribute of the frame; a status acquisition unit that acquires communication control status information indicating a communication control status of the frame by the in-vehicle electronic device; and an abnormality detection unit that detects an abnormality of the in-vehicle electronic device on the basis of the attribute and the communication control status.

Furthermore, an intrusion detection device according to a second embodiment of the present disclosure includes a communication unit that transmits and receives a frame to and from an in-vehicle electronic device; an attribute acquisition unit that acquires an attribute of the frame; a status acquisition unit that acquires communication control status information indicating a communication control status of the frame by the in-vehicle electronic device; an abnormality determination unit that detects an abnormality of the in-vehicle electronic device; and
a transmission unit that, when the abnormality determination unit detects the abnormality of the in-vehicle electronic device, adds the attribute and the communication control status information to the abnormality information indicating the abnormality and transmits the abnormality information.

### Advantageous Effects of Invention

The intrusion detection device of the present disclosure enables detection of unauthorized communication to be performed more accurately.

### BRIEF DESCRIPTION OF DRAWINGS

FIG. 1 is a block diagram showing an example of a configuration of an intrusion detection device 100 according to a first embodiment.

FIG. 2 is a block diagram illustrating details of the configuration of the intrusion detection device 100.

FIG. 3 shows an example of a communication control status table included in a status acquisition unit 103.

FIG. 4 is an example of a determination table used by the frame transmission determination unit 104 to determine the normality/abnormality of ECUs 20.

FIG. 5 shows an example of a communication control group table included in a status determination unit 105.

FIG. 6 is a flowchart showing operations according to the first embodiment.

FIG. 7 is a flowchart showing operations according to the first embodiment.

FIG. 8 is a block diagram showing an example of a configuration of an intrusion detection device 100′ according to a second embodiment.

### DESCRIPTION OF EMBODIMENTS

The present embodiment will be described hereinbelow with reference to the drawings. In the accompanying drawings, constituent elements which are functionally the same may be denoted by the same numbers. Note that, although the accompanying drawings illustrate embodiments and implementation examples conforming to the principles of the present disclosure, these drawings facilitate understanding of the present disclosure and are not used to interpret the present disclosure in a limited manner. The description herein is only a typical example and is not intended to limit the patent claims or application examples of the disclosure in any way.

In the present embodiment, the description has been provided with sufficient detail for those skilled in the art to implement the present disclosure; however, it should be understood that other embodiments and modes of carrying out the present disclosure are also possible, and that changes in the configurations and structures as well as replacement of various constituent elements are possible without departing from the scope and spirit of the technical concepts of the present disclosure. Therefore, the following description should not be interpreted as limiting the present disclosure thereto. The control lines and information lines illustrated in the various drawings indicate what is considered to be necessary for the description of the invention, and do not indicate all the control lines and information lines in an actual product.

### First Embodiment

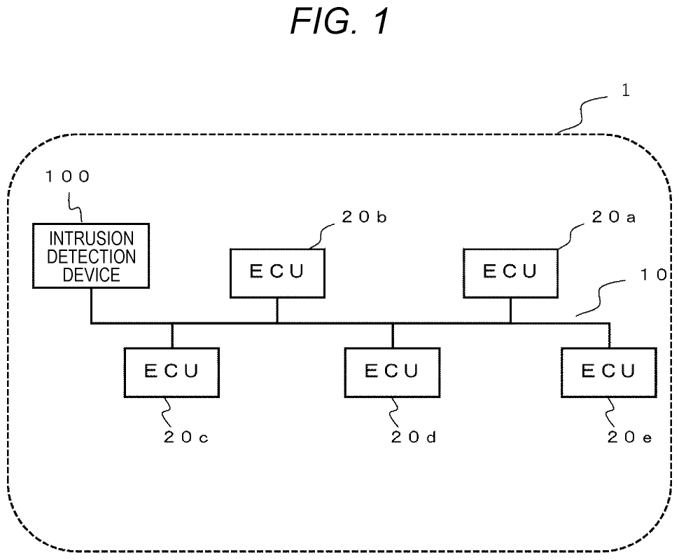

First, an intrusion detection device 100 according to a first embodiment will be described with reference to a block diagram in FIG. 1. FIG. 1 is a block diagram showing an example of a configuration of the intrusion detection device 100 according to the first embodiment. An in-vehicle network 1 is configured such that the intrusion detection device 100 and a plurality of ECUs 20a to 20e (in-vehicle electronic devices) are connected to a network 10. Although five ECUs 20a to 20e are illustrated in FIG. 1 for simplicity of description, needless to say, the present invention is not limited to having five ECUs.

The network 10 is a network in which the intrusion detection device 100 and the plurality of ECUs 20 are connected, and is used for data communication. The telecommunications standard may be CAN, Ethernet, SPI, or the like, and is not limited to a specific standard. Note that, hereinafter, the plurality of ECUs 20a to 20e may be collectively referred to as the “ECUs 20”.

The ECUs 20 are calculation control devices for executing calculations in order to execute various types of vehicle-related control. The plurality of ECUs 20 mutually exchanges messages (hereinafter, also referred to as “frames” and “data”) using the network 10. In a frame, a transmission source and a transmission destination are defined in advance by identification information such as an ID, and the ECUs 20 are capable of receiving the frame on the basis of the identification information. The ECUs 20 may be information processing devices connected to the network 10 or may be external devices such as diagnostic devices connected by means of an interface such as on-board diagnostics (OBD).

The intrusion detection device 100 is an information processing device that monitors the network 10 to detect unauthorized communication (intrusion into the ECUs 20 or an attack activity) from the outside. In addition, the intrusion detection device 100 may be an information processing device that simultaneously implements the functions of the ECUs 20.

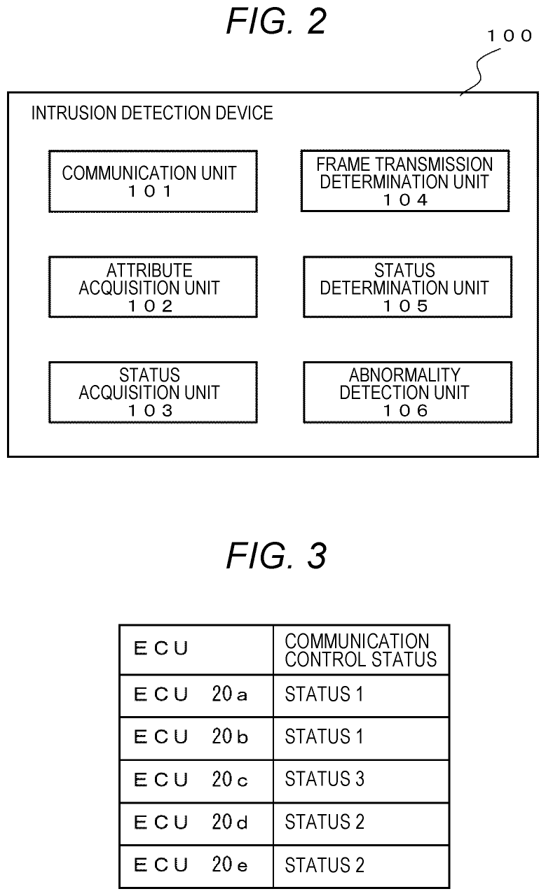

FIG. 2 is a block diagram showing an example of a configuration of the intrusion detection device 100 according to the first embodiment. As an example, the intrusion detection device 100 includes a communication unit 101, an attribute acquisition unit 102, a status acquisition unit 103, a frame transmission determination unit 104, a status determination unit 105, and an abnormality detection unit 106.

The communication unit 101 transmits and receives frames to and from the network 10. A frame received by the communication unit 101 is outputted to the attribute acquisition unit 102. Furthermore, in a case where the frame transmitted and received by the communication unit 101 is a frame pertaining to a communication control status to be described below, the frame is outputted to the status acquisition unit 103.

The attribute acquisition unit 102 acquires attribute information regarding attributes of the frame from the frame acquired by the communication unit 101. The acquired frame attribute information is defined in the in-vehicle network 1 in advance, and includes, as an example, an ID included in the frame, a timing at which the frame is transmitted, a payload (actual data portion) of the frame, and the like. The attribute acquisition unit 102 outputs, to the frame transmission determination unit 104, the acquired attributes and information on the ECU 20 constituting the transmission source of the frame.

The status acquisition unit 103 acquires communication control status information on the status of the communication control by the ECU 20 of the frame received by communication unit 101. The communication control status information is defined in advance in the in-vehicle network 1 so as to indicate any of a plurality of statuses. The status of the communication control by the ECU 20 changes depending on internal and external factors of the ECU 20. The communication control status information is information indicating the current status of the ECU 20.

An example of a protocol that defines a communication control status is AUTOSAR CAN Network Management (CanNm). CanNm is a protocol related to communication control defined by AUTOSAR, and is a protocol for continuously communicating the activation status of a group of ECUs (PN cluster) that need to communicate at the same time regardless of the status of an ignition power supply of the vehicle. In CanNm, five communication control statuses are defined, and transitions in the communication control status of the ECU occur due to factors which are referred to as an internal request and an external request.

An internal request means that, in a case where the ECU determines that it is necessary to continue activation due to an internal factor of the ECU, the ECU requests continuation of its own operation. In contrast, an external request is indicated using an NM frame transmitted in three communication control statuses called network modes. Specifically, there is a region allocated for each PN cluster in the NM frame, and whether there is a communication request from the same PN cluster is determined by checking the region when the NM frame is received. In the in-vehicle network 1 using CanNm, the type and attribute of a frame that can be transmitted and received in each of a plurality of communication control statuses may be defined. The intrusion detection device 100 according to the present embodiment determines a combination of the communication control status and the attribute of the transmitted frame by utilizing the fact that the attribute of the frame that can be transmitted and received is defined by the communication control status, and detects unauthorized communication based on the determination result.

One method which may be used by the status acquisition unit 103 to acquire the communication control status information indicating the communication control status of the ECU 20 is to directly receive the communication control status information from the ECU 20. The status acquisition unit 103 is also capable of determining the communication control status from the communication status of the frame transmitted and received to/from the target ECU, and of acquiring information including the determination content as the communication control status information.

In the example of CanNm described above, which communication control status each ECU 20 is in can be estimated from the content of the NM frame flowing on the network 10 and PN cluster information for each ECU 20. That is, an NM frame and a PN cluster are capable of functioning together as the communication control status information. The communication control status information acquired by the status acquisition unit 103 is managed by the status acquisition unit 103 for each of the ECUs 20a to 20e in the communication control status table shown by way of example in FIG. 3, and is outputted to the frame transmission determination unit 104 and the status determination unit 105. In FIG. 3, status 1, status 2, and status 3 are defined as the communication control statuses of the ECUs 20a to 20e, and which status the communication control status of each of the ECUs 20a to 20e pertains to is indicated by the communication control status information.

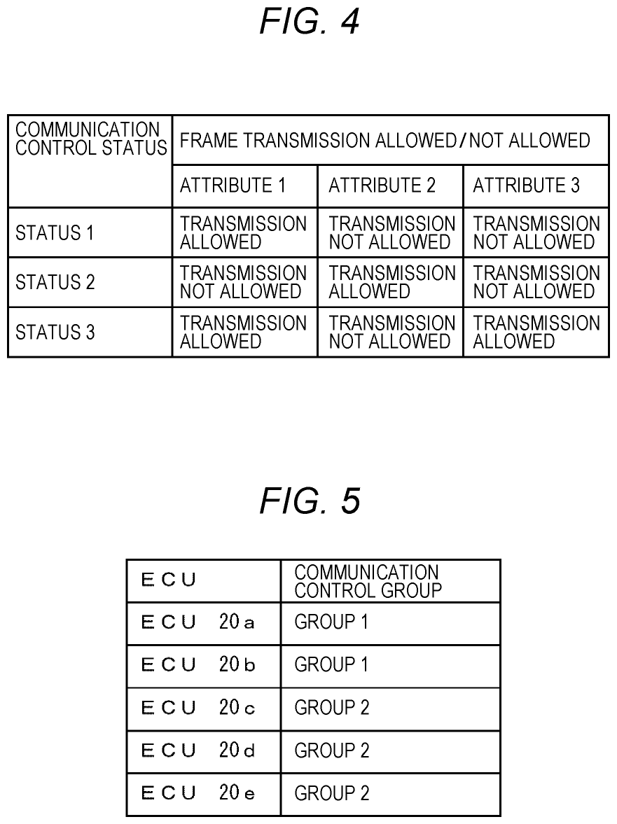

Based on the combination of the attribute information acquired from the attribute acquisition unit 102 and the communication control status information acquired from the status acquisition unit 103, the frame transmission determination unit 104 determines whether or not the ECU 20 constituting the transmission source of the frame received by the communication unit 101 is allowed to transmit the frame and whether the ECU 20 is normal or abnormal. FIG. 4 is an example of a determination table used by the frame transmission determination unit 104 to determine the normality/abnormality of the ECUs 20.

This determination table is a table for determining whether the ECUs 20 are normal or abnormal for each of the combinations (nine ways) of the statuses 1 to 3 indicated by the communication control status information and the attributes 1 to 3 indicated by an attribute signal, and determining that the ECUs 20 are capable of transmitting a frame (transmission is allowed) in a case where it is determined that the status is normal, and determining that the ECUs are not capable of transmitting a frame (transmission is not allowed) in a case where it is determined that the status is abnormal. For example, it is assumed that the communication control statuses of the ECUs 20a to 20e are the statuses showing in FIG. 3 (ECUs 20a and 20b have status 1, ECUs 20d and 20e have status 2, and ECU 20c have status 3). At this time, for example, in a case where the attribute of the frame received from the ECU 20c is attribute 2, it is determined, according to the determination table of FIG. 4, that the ECU 20c is abnormal and transmission is not allowed. The determination result by the frame transmission determination unit 104 is outputted to the abnormality detection unit 106.

The status determination unit 105 determines whether the ECUs 20 are normal or abnormal on the basis of the communication control status information acquired from the status acquisition unit 103 and the communication control group table as shown in FIG. 5. The communication control group is a group including the ECUs 20 in which communication control statuses at arbitrary timings are always common (identical). The communication control group corresponds to the PN cluster in the foregoing CanNm example.

As an example, as shown in FIG. 5, it is assumed that the ECUs 20a and 20b are classified into a group 1 as a communication control group, and the ECUs 20c to 20e are classified into a group 2 as a communication group. In this case, for example, in an instance where the communication control status information of the ECUs 20d and 20e indicates the status 1 while the communication control status of the ECU 20c belonging to the same group 2 indicates the status 2, the status determination unit 105 is capable of determining that the ECU 20c is abnormal. The determination result by the status determination unit 105 is outputted to the abnormality detection unit 106.

The abnormality detection unit 106 has a function for finally determining whether an ECU 20 is abnormal (detecting abnormality) using one or both of the determination result of frame transmission determination unit 104 and the determination result of status determination unit 105. In a case where the normality/abnormality of an ECU 20 is determined using both determination results, it is possible to determine the normality/abnormality of the ECU 20 with higher accuracy as compared with a case where either one of the determination results is used.

Even in a case where the normality/abnormality of an ECU 20 is determined only using the determination result of frame transmission determination unit 104, the normality/abnormality of the ECU 20 can be determined with sufficient accuracy. For example, even in a case where an unauthorized message is transmitted such that the number of messages transmitted from the ECU 20 per unit time is equal to or less than a threshold value, the frame transmission determination unit 104 is capable of determining whether the frame is normal or abnormal by using a combination of the communication control status information indicating the status of the frame and the attribute information indicating the attributes of the frame. That is, the abnormality detection unit 106 is capable of determining the normality/abnormality of the ECU 20 by using only the determination result from the frame transmission determination unit 104, and even in this case, is capable of detecting unauthorized communication more accurately in comparison with a case where the determination is made on the basis of the number of messages from the ECU 20 per unit time.

However, even though the communication control status information acquired by the status acquisition unit 103 actually relates to unauthorized communication, the fact that the communication control status information is unauthorized may not be reflected in the communication control status information. Specifically, it is conceivable that, in order to falsify the validity of the transmission of an unauthorized message, an attack device spoofing an ECU 20 performs data manipulation such that a frame of its own unauthorized message is determined to be valid. In order to handle such a situation, the abnormality detection unit 106 is capable of determining whether the ECU 20 is normal or abnormal by using both the determination result of the frame transmission determination unit 104 and the determination result of the status determination unit 105. The status determination unit 105 is capable of determining whether the ECU 20 is normal or abnormal by focusing on a communication control group in which a communication control status at an arbitrary timing is always common. That is, even in a case where the attack device falsifies the frame pertaining to its own communication control status, the abnormality detection unit 106 is capable of accurately determining whether the ECU 20 is normal or abnormal by checking the communication control statuses of the ECUs 20 belonging to the communication control group common to the attack device.

The abnormality determination timing by the abnormality detection unit 106 is not limited to a specific timing, rather, the determination may be appropriately executed at the timing when the abnormality detection unit 106 receives a determination result from the frame transmission determination unit 104 or the status determination unit 105, or the abnormality determination may be executed in a constant cycle regardless of the reception timing. Further, the abnormality determination by the abnormality detection unit 106 may take into account hysteresis of the determination results of the frame transmission determination unit 104 and the status determination unit 105.

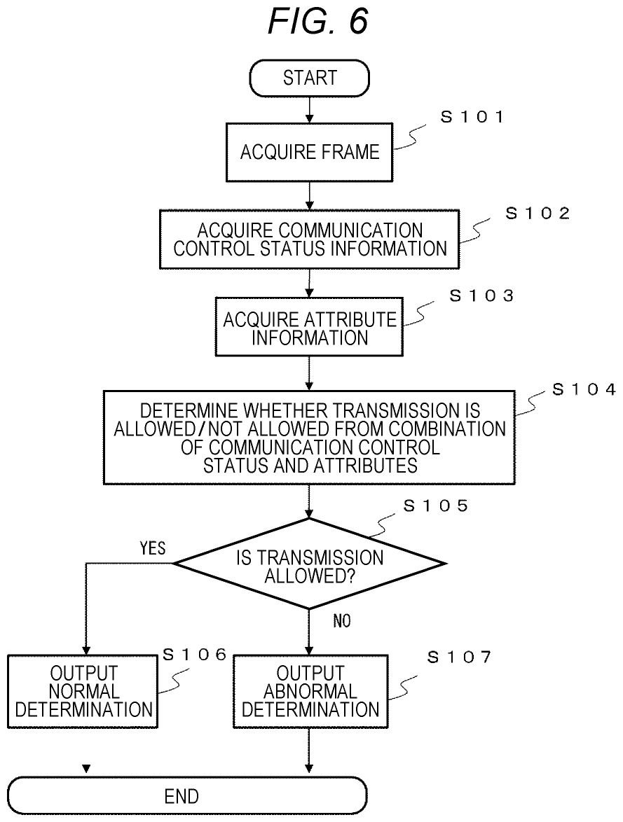

An example of an operation for determining the normality/abnormality of the ECUs 20 in the intrusion detection device 100 according to the first embodiment will be described with reference to a flowchart in FIG. 6. FIG. 6 shows an operation in a case where the abnormality detection unit 106 determines the normality/abnormality of the ECUs 20 by using only the determination result of the frame transmission determination unit 104. First, the communication unit 101 acquires (receives) a frame (a received frame) transmitted from the ECUs 20 (step S101). Subsequently, in a case where a received frame is a frame indicating the communication control status, the status acquisition unit 103 acquires the communication control status information from the frame (step S102). As shown in FIG. 3, the acquired communication control status information is updated and stored as information on the latest communication control statuses of the ECUs 20. Subsequently, the attribute acquisition unit 102 acquires attribute information indicating the attributes of the received frame (step S103).

The frame transmission determination unit 104 acquires the attribute information of the frame acquired from the attribute acquisition unit 102 and the communication control status information held in the status acquisition unit 103 as the internal information, and determines whether transmission of the frame is allowed or not allowed by referring to the determination table (FIG. 4) pertaining the combination (step S104). In a case where the determination table indicates that the frame pertaining to the combination of the attribute information and the communication control status information can be transmitted (YES in step S105), the frame transmission determination unit 104 transmits the information to the abnormality detection unit 106. The abnormality detection unit 106 determines, according to the information, that the ECU 20 constituting the transmission source of the frame is normal (step S106). On the other hand, in a case where the determination table indicates that transmission of the frame pertaining to the combination of the attribute information and the communication control status information is not allowed (NO in step S105), the frame transmission determination unit 104 transmits the information to the abnormality detection unit 106. The abnormality detection unit 106 determines, according to the information, that the ECU 20 constituting the transmission source of the frame is abnormal (step S107).

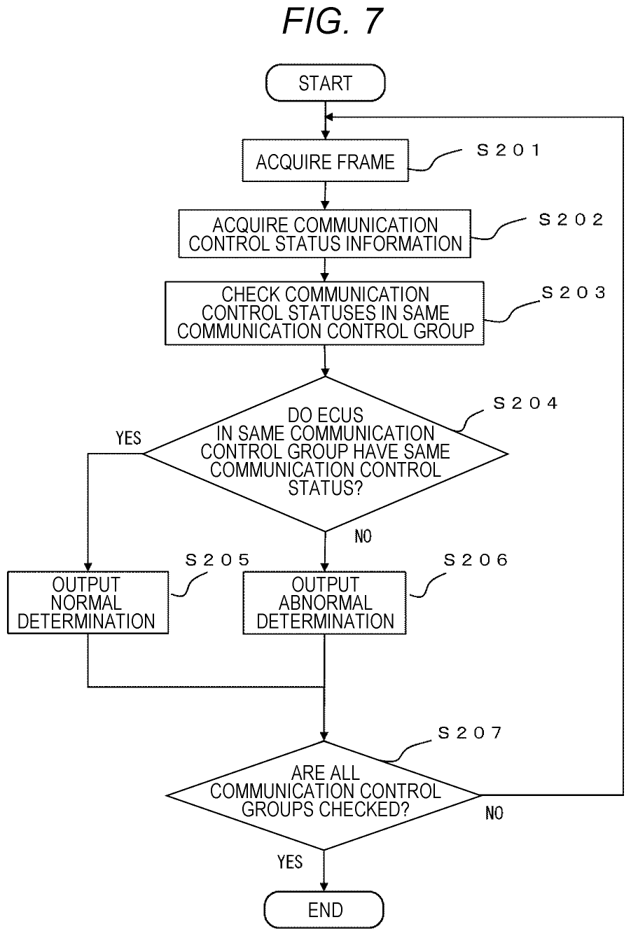

Another example of an operation for determining the normality/abnormality of the ECU 20 in the intrusion detection device 100 according to the first embodiment will be described with reference to the flowchart in FIG. 7. FIG. 7 shows an operation in a case where the abnormality detection unit 106 determines the normality/abnormality of the ECU 20 by using only the determination result of the status determination unit 105.

First, the communication unit 101 acquires a frame from each of the ECUs 20a to 20e (step S201) and acquires communication control status information on the ECUs 20a to 20e transmitting the frames (step S202). The status determination unit 105 then checks the communication control statuses of the ECUs 20 belonging to the same communication control group (step S203). For example, in a case where the ECUs 20a to 20e are grouped as shown in FIG. 5, the communication control status information of the frames transmitted by the ECUs 20a and 20b belonging to group 1 is collectively checked. Similarly, the communication control status information of the frames transmitted by the ECUs 20c to 20e belonging to group 2 may be collectively checked.

In step S204, it is determined whether or not, according to the result of the check in step S203, the ECUs 20 in the same communication control group have the same communication control statuses. When the determination result is affirmative, the processing advances to step S205, and it is determined that the ECUs 20 in the same communication control group are normal. On the other hand, when the determination result is negative, the processing advances to step S206, and it is determined that the ECUs 20 in the same communication control group have abnormal statuses. In this manner, the above operation is repeated until checking is complete for all the communication control groups (step S207).

Note that, in the above flowchart, the case where the communication control statuses of the ECUs 20 belonging to the same communication control group are the same has been described as an example, but this is merely an example, and it is also possible to determine whether the ECUs 20 are normal or abnormal by defining the abnormal statuses of the ECUs 20 in advance according to the distribution of the communication control statuses of the ECUs 20 belonging to the same communication control group and specifying the distribution of the communication control status information obtained. That is, in a case where the communication control statuses of the ECUs 20 in the same communication control group have a certain relationship, it can be determined that the communication is normal.

A distribution-related signal which is obtained may be added to the output signal outputted by the abnormality detection unit 106 and outputted from the abnormality detection unit 106. For example, in a case where only one ECU 20 in the same communication control group has a different communication control status, it is possible to issue an output, constituting a first abnormal status, to the abnormality detection unit 106 to the effect that the ECU 20 is abnormal. In addition, in a case where the ECUs 20 in the same communication control group each have different communication control statuses, it is possible to issue an output, constituting a second abnormal status, to the abnormality detection unit 106 to the effect that all the ECUs 20 in the same communication control group are abnormal. Further, a format may be adopted for the abnormality detection unit 106 where same makes a final abnormality determination according to the abnormal status outputted from the status determination unit 105.

As described above, the flowchart of FIG. 6 shows the operation in a case where the abnormality detection unit 106 determines the normality/abnormality of the ECU 20 by using only the determination result of the frame transmission determination unit 104, and the flowchart of FIG. 7 shows the operation in a case where the abnormality detection unit 106 determines the normality/abnormality of the ECU 20 by using only the determination result of the status determination unit 105. In a case where the abnormality detection unit 106 determines whether the ECU 20 is normal or abnormal in accordance with both the determination result of the frame transmission determination unit 104 and the determination result of the status determination unit 105, the procedure of FIG. 6 and the procedure of FIG. 7 may be executed in parallel.

As described above, the first embodiment enables detection of unauthorized communication to be performed more accurately. Specifically, whether the ECU 20 constituting the transmission source of the frame is normal or abnormal can be determined according to the attribute information of the frame being transmitted and the communication control status information. Further, the status determination unit 105 determines whether the ECU 20 constituting the transmission source of the frame, is normal or abnormal on the basis of the definition of the communication control group and the communication control status information. The abnormality detection unit 106 is capable of determining whether the ECU 20 constituting the transmission source of the frame is normal or abnormal according to one or both of the determination result of the frame transmission determination unit 104 and the determination result of the status determination unit 105. Therefore, according to the first embodiment, even when the number of frames transmitted per unit time is equal to or less than a predetermined value, it is possible to determine abnormality of the ECU 20 according to the combination of the communication control status of the ECU 20 constituting the transmission source of the frame and the attributes of the frame, as well as the identity of the communication control group.

### Second Embodiment

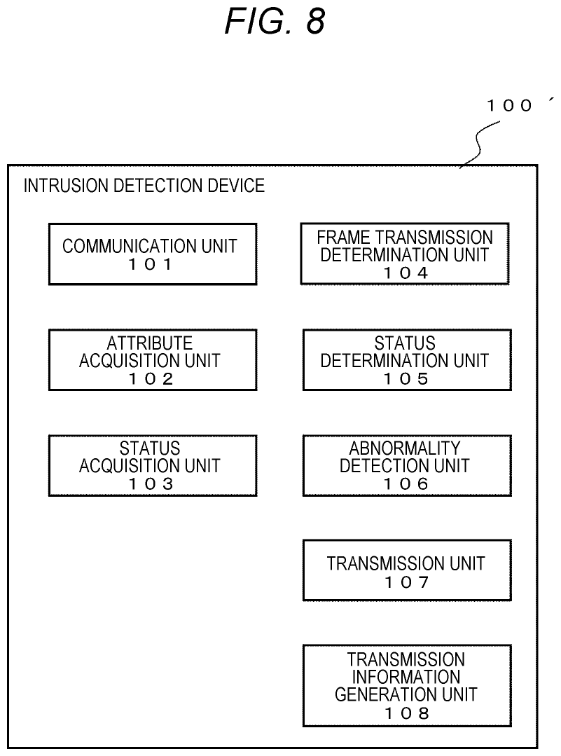

Next, an intrusion detection device 100′ according to a second embodiment will be described with reference to FIG. 8. The intrusion detection device 100′ according to the second embodiment is connected to the ECUs 20 via a network, similarly to the intrusion detection device 100 according to the first embodiment. However, as shown in FIG. 8, the intrusion detection device 100′ has a configuration which is partially different from that of the intrusion detection device 100.

As shown in FIG. 8, the intrusion detection device 100′ according to the second embodiment also includes a transmission unit 107 and a transmission information generation unit 108 in addition to the configurations of the intrusion detection device 100 according to the first embodiment. Other configurations are similar to those of the intrusion detection device 100 according to the first embodiment, and the same components are denoted by the same reference signs in FIG. 8.

When the abnormality detection unit 106 detects the abnormality of the ECU 20 in the same manner as in the first embodiment, the transmission unit 107 transmits the abnormality information to the outside. The abnormality information is information indicating that ECU 20 is abnormal, which is specifically determined by the frame transmission determination unit 104 or the status determination unit 105. The transmission destination of the abnormality information is, for example, an external device, a server, or the like, but is not limited to a specific device. For instance, a security operation center (SOC) is considered as another example. By using the transmission unit 107 to transmit the abnormality information, it is possible to grasp the occurrence of a threat or an attack outside, thus allowing countermeasures to be taken.

The transmission information generation unit 108 has a function for generating transmission information which is to be added to the abnormality information transmitted from the transmission unit 107. As an example, the transmission information includes the attributes of the frame acquired by attribute acquisition unit 102 and the communication control status information of the ECU 20 acquired by the status acquisition unit 103. Communication control status information pertaining to the plurality of ECUs 20a to 20e may also be assigned to one piece of abnormality information. For example, the communication control status information of another ECU 20 belonging to the same communication control group as that of one ECU 20 which has transmitted the abnormal frame may be assigned together with the communication control status information of the one ECU 20. In a case where the communication control status information for the plurality of ECUs 20 is assigned to one piece of abnormality information, the transmission amount of the transmission unit 107 increases, but it is possible to grasp the situation more easily at the time an abnormality occurs. For example, in a case where the data is transmitted to the SOC, the data can be used for triage or a secondary analysis of the abnormality by an analyst.

Note that the present invention is not limited to or by the above-described embodiments and includes various modifications. The above-described embodiments have each been described in detail to facilitate understanding of the present invention, and the present invention is not necessarily limited to having all the described configurations. Further, part of the configuration of one embodiment can be replaced with the configuration of another embodiment, and the configuration of the other embodiment can be added to the configuration of the one embodiment. In addition, it is possible to add, delete, and replace other configurations with some of the configurations of each embodiment.

In addition, some or all of the above-described configurations, functions, processing units, processing means, and the like may be implemented by means of hardware, for example, through an integrated circuit design. Moreover, each of the above-described configurations and functions may be implemented by software as a result of a processor parsing and executing a program for implementing each function. Information such as a program, a table, and a file for realizing each function may be stored in a recording device such as a memory, a hard disk, or an SSD, or on a recording medium such as an IC card, an SD card, or a DVD.

### Reference Signs List

1 in-vehicle network
10 network
20a to 20e ECU
100 intrusion detection device
101 communication unit
102 attribute acquisition unit
103 status acquisition unit
104 frame transmission determination unit
105 status determination unit
106 abnormality detection unit
107 transmission unit
108 transmission information generation unit

1. An intrusion detection device, comprising:
a communication unit that transmits and receives a frame to and from an in-vehicle electronic device;
an attribute acquisition unit that acquires an attribute of the frame;
a status acquisition unit that acquires communication control status information indicating a communication control status of the frame by the in-vehicle electronic device; and
an abnormality detection unit that detects an abnormality of the in-vehicle electronic device on the basis of the attribute and the communication control status.

2. The intrusion detection device according to claim 1, further comprising a frame transmission determination unit that determines whether or not transmission of the frame is allowed on the basis of the attribute and the communication control status,
wherein the abnormality detection unit detects an abnormality on the basis of a determination result of the frame transmission determination unit.

3. The intrusion detection device according to claim 1, further comprising a status determination unit that determines whether or not the in-vehicle electronic devices belonging to the same group have the same communication control status,
wherein the abnormality detection unit detects an abnormality on the basis of a determination result of the status determination unit.

4. The intrusion detection device according to claim 1, further comprising:
a frame transmission determination unit that determines whether or not transmission of the frame is allowed on the basis of the attribute and the communication control status; and
a status determination unit that determines whether or not the communication control statuses of the in-vehicle electronic devices belonging to the same group have a certain relationship,
wherein the abnormality detection unit detects an abnormality of the in-vehicle electronic device on the basis of either a determination result of the frame transmission determination unit or a determination result of the status determination unit.

5. An intrusion detection device, comprising:
a communication unit that transmits and receives a frame to and from an in-vehicle electronic device;
an attribute acquisition unit that acquires an attribute of the frame;
a status acquisition unit that acquires communication control status information indicating a communication control status of the frame by the in-vehicle electronic device;
an abnormality determination unit that detects an abnormality of the in-vehicle electronic device; and
a transmission unit that, when the abnormality determination unit detects the abnormality of the in-vehicle electronic device, adds the attribute and the communication control status information to abnormality information indicating the abnormality and transmits the abnormality information.

6. An intrusion detection method, comprising the steps of:
transmitting and receiving a frame to and from an in-vehicle electronic device;
acquiring an attribute of the frame;
acquiring communication control status information indicating a communication control status of the frame by the in-vehicle electronic device; and
detecting an abnormality of the in-vehicle electronic device on the basis of the attribute and the communication control status.

7. The intrusion detection method according to claim 6, further comprising:
a first step of determining whether or not transmission of the frame is allowed on the basis of the attribute and the communication control status,
wherein the step of detecting the abnormality detects the abnormality on the basis of a determination result of the first step.

8. The intrusion detection method according to claim 6, further comprising:
a second step of determining whether or not the communication control statuses of the in-vehicle electronic devices belonging to the same group have a certain relationship,
wherein the step of detecting the abnormality detects the abnormality on the basis of a determination result of the second step.

9. The intrusion detection method according to claim 6, further comprising:
a first step of determining whether or not transmission of the frame is allowed on the basis of the attribute and the communication control status; and
a second step of determining whether or not the communication control statuses of the in-vehicle electronic devices belonging to the same group have a certain relationship,
wherein the step of detecting the abnormality detects the abnormality on the basis of a determination result of the first step and a determination result of the second step.
